(19) United States
(12) Patent Application Publication
(10) Pub. No.: US 2024/0363877 A1
(43) Pub. Date: Oct. 31, 2024

(54) HYDROGEN SUPPLY DEVICE

(71) Applicant: TOYOTA JIDOSHA KABUSHIKI KAISHA, Toyota-shi (JP)

(72) Inventors: Hiroaki KOSAKA, Toyota-shi (JP); Yoshifumi Kawakami, Toyota-shi (JP); Tomoyuki Matsuo, Toyota-shi (JP); Tomohiro Nakano, Nagoya-shi (JP)

(73) Assignee: TOYOTA JIDOSHA KABUSHIKI KAISHA, Toyota-shi (JP)

(21) Appl. No.: 18/597,017

(22) Filed: Mar. 6, 2024

(30) Foreign Application Priority Data
Apr. 27, 2023 (JP) 2023-073222

(51) Int. Cl. H01M 8/04746; H01M 8/04029; H01M 8/04082; H01M 8/0432; H01M 8/04537

(52) U.S. Cl. CPC H01M 8/04768; H01M 8/04029; H01M 8/04208; H01M 8/04328; H01M 8/04604

(57) ABSTRACT

A heater, a vaporizer, a circulation flow path that circulates the heating medium between the heater and the vaporizer, a bypass flow path connected to the circulation flow path so as to bypass the heater, a heater inlet valve and a bypass valve that switch flow paths between a first flow path in which the heating medium flows through the heater and does not flow through the bypass flow path, and a second flow path, and a control unit are included. The control unit switches a flow path of the heating medium to the first flow path when a vaporizer inlet heating medium temperature is lower than a set temperature, and switches the flow path of the heating medium to the second flow path when the vaporizer inlet heating medium temperature is no lower than the set temperature.

### CROSS-REFERENCE TO RELATED APPLICATION

This application claims priority to Japanese Patent Application No. 2023-073222 filed on Apr. 27, 2023, incorporated herein by reference in its entirety.

### BACKGROUND

### 1. Technical Field

The disclosure relates to temperature control of hydrogen gas in a hydrogen supply device that vaporizes liquid hydrogen and supplies hydrogen gas.

### 2. Description of Related Art

Japanese Unexamined Patent Application Publication No. 8-284761 (JP 8-284761 A) discloses technology for changing a fuel flow rate in a vaporizer that vaporizes fuel to be supplied to an engine, in accordance with the ambient temperature.

### SUMMARY

Now, in recent years, hydrogen engine vehicles, equipped with hydrogen engines that directly burn hydrogen gas instead of gasoline, have come into use. In these hydrogen engine vehicles, a method is used in which hydrogen gas, obtained by vaporizing liquid hydrogen, is supplied to the hydrogen engine. When temperature of the hydrogen gas supplied to the hydrogen engine is too high, output of the hydrogen engine will decrease, and when the temperature of the hydrogen gas is too low, hydrogen piping may be damaged by the hydrogen gas that is ultracold. Thus, maintaining the hydrogen gas supplied to the hydrogen engine within a predetermined temperature range is required.

Accordingly, it is an object of a hydrogen supply device according to the present disclosure to maintain temperature of hydrogen gas supplied to a power plant to be within a predetermined temperature range.

A hydrogen supply device according to the present disclosure includes a heater that heats a heating medium, a vaporizer that vaporizes liquid hydrogen into hydrogen gas using the heating medium that is heated, a circulation flow path that circulates the heating medium between the heater and the vaporizer, a bypass flow path connected to the circulation flow path so as to bypass the heater, a switching valve that switches flow paths between a first flow path in which the heating medium flows through the heater and does not flow through the bypass flow path, and a second flow path in which the heating medium flows through the bypass flow path and does not flow through the heater, and a control unit that adjusts operation of the switching valve. The control unit is configured to switch a flow path of the heating medium to the first flow path by the switching valve when a temperature of the heating medium flowing into the vaporizer is lower than a set temperature, and switch the flow path of the heating medium to the second flow path by the switching valve when the temperature of the heating medium flowing into the vaporizer is no lower than the set temperature.

Thus, the temperature of the hydrogen gas flowing out from the vaporizer can be maintained within the predetermined temperature range.

In the hydrogen supply device according to the present disclosure, the control unit may be configured to receive input of output of a power plant to which the hydrogen gas flowing out from the vaporizer is supplied, and of temperature of the hydrogen gas flowing out from the vaporizer, and calculate the set temperature based on the temperature of the hydrogen gas flowing out from the vaporizer, and the output of the power plant.

Thus, even when the output of the power plant changes, the temperature of the hydrogen gas supplied to the power plant can be maintained within the predetermined temperature range.

In the hydrogen supply device according to the present disclosure, the control unit may be configured to calculate a base set temperature based on the temperature of the hydrogen gas flowing out from the vaporizer, calculate a set temperature correction value based on the output of the power plant, and set a sum of the base set temperature and the set temperature correction value as the set temperature.

Thus, the set temperature can be calculated in accordance with the output of the power plant.

In the hydrogen supply device according to the present disclosure, the control unit may be configured to calculate the base set temperature such that the base set temperature becomes lower as the temperature of the hydrogen gas flowing out from the vaporizer rises, and calculate the set temperature correction value such that the set temperature correction value increases as the output of the power plant increases.

Thus, the set temperature can be calculated in accordance with the temperature of the hydrogen gas flowing out from the vaporizer, and the output of the power plant.

The hydrogen supply device according to the present disclosure can maintain the temperature of the hydrogen gas supplied to the power plant within the predetermined temperature range.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a system diagram showing the configuration of a hydrogen supply device according to an embodiment and a hydrogen engine vehicle equipped with the hydrogen supply device;

FIG. 2 is a base set temperature calculation map stored in the memory of the control unit shown in FIG. 1;

FIG. 3 is a map for calculating the set temperature correction value stored in the memory of the control unit shown in FIG. 1; and

FIG. 4 is a flowchart showing the operation of the hydrogen supply device shown in FIG. 1.

### DETAILED DESCRIPTION OF EMBODIMENTS

Hereinafter, a hydrogen supply device 100 according to an embodiment will be described with reference to the drawings. In the following description, hydrogen supply device 100 will be described as one that supplies hydrogen gas to hydrogen engine 15, which is a power plant mounted on hydrogen engine vehicle 200.

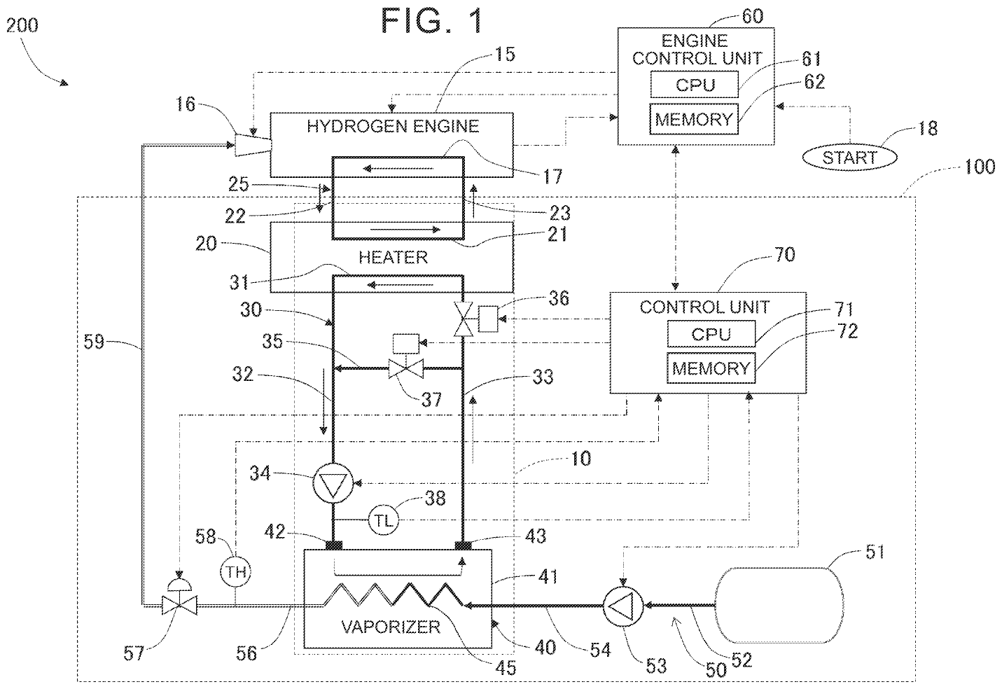

As shown in FIG. 1, the hydrogen supply device 100 includes a heating circuit 10 that heats a heating medium and supplies it to the vaporizer 40, a hydrogen circuit 50 that supplies the hydrogen gas vaporized in the vaporizer 40 to the hydrogen engine 15, A control unit 70 is provided. First, the heating circuit 10 will be explained. The heating circuit 10 includes a heater 20, a vaporizer 40, a circulation flow path 30, a bypass flow path 35, a circulation pump 34, a heater inlet valve 36, and a bypass valve 37.

The heater 20 includes a coolant flow path 21 and a heating medium flow path 31 inside. The high-temperature coolant that has passed through the internal flow path 17 of the hydrogen engine 15 flows through the coolant flow path 21. The low-temperature heating medium that has passed through the inside of the casing 41 of the vaporizer 40 flows through the heating medium flow path 31. The heater 20 heats the heating medium by exchanging heat between the high temperature coolant flowing through the coolant flow path 21 and the low temperature heating medium. Here, the heating medium is a liquid, and may be a long life coolant (LLC), for example.

The coolant flow path 21 is connected to the internal flow path 17 by a coolant supply pipe 22 and a coolant return pipe 23. The internal flow path 17, the coolant flow path 21, the coolant supply pipe 22, and the coolant return pipe 23 form a coolant circulation flow path 25 that circulates coolant between the hydrogen engine 15 and the heater 20. do. The coolant circulation flow path 25 circulates the coolant whose temperature has increased in the hydrogen engine 15 to the coolant flow path 21 of the heater 20.

The vaporizer 40 includes a casing 41 and a hydrogen tube 45 housed inside the casing 41. A high-temperature heating medium heated by the heater 20 flows inside the casing 41. Low temperature liquid hydrogen or hydrogen gas flows inside the hydrogen tube 45. The heating medium flowing through the inside of the casing 41 flows on the outer surface of the hydrogen tube 45, heats and vaporizes the liquid hydrogen inside, and turns it into hydrogen gas.

The circulation flow path 30 includes a heating medium flow path 31 of the heater 20, a heating medium supply pipe 32, a casing 41 of the vaporizer 40, and a heating medium return pipe 33. The heating medium supply pipe 32 connects the outlet of the heating medium flow path 31 and the heating medium inlet 42 of the vaporizer 40. The heating medium return pipe 33 connects the heating medium outlet 43 of the vaporizer 40 and the inlet of the heating medium flow path 31. Further, the heating medium supply pipe 32 is provided with a circulation pump 34 that circulates the heating medium in the circulation flow path 30. Further, a heating medium temperature sensor 38 is provided near the heating medium inlet 42 of the heating medium supply pipe 32 to detect the vaporizer inlet heating medium temperature TL.

The heating medium pressurized by the circulation pump 34 flows into the casing 41 from the heating medium inlet 42 through the heating medium supply pipe 32. The heating medium flows on the outer surface of the hydrogen tube 45 inside the casing 41 and exchanges heat with the low-temperature liquid hydrogen flowing inside the hydrogen tube 45, thereby reducing its temperature. The heating medium whose temperature has decreased flows out from the heating medium outlet 43 of the vaporizer 40 to the heating medium return pipe 33. The heating medium flows into the heating medium flow path 31 of the heater 20 from the heating medium return pipe 33. Then, the heating medium whose temperature has increased by exchanging heat with the high-temperature coolant flowing through the coolant flow path 21 in the heating medium flow path 31 returns to the circulation pump 34 from the heating medium supply pipe 32.

The bypass flow path 35 connects the heating medium supply pipe 32 and the heating medium return pipe 33 so as to bypass the heating medium flow path 31. A bypass valve 37 is provided in the bypass flow path 35. Further, a heater inlet valve 36 is provided in the heating medium return pipe 33 between the branch point of the bypass flow path 35 and the inlet of the heating medium flow path 31. The bypass valve 37 and the heater inlet valve 36 are defined as a switching valve configured to switch the flow path between a first flow path in which the heating medium passes through the heater 20 and not through the bypass flow path 35, and a second flow path in which the heating medium passes through the bypass flow path 35 and not through the heater 20. That is, when the heater inlet valve 36 is open and the bypass valve 37 is closed, a first flow path is formed in which the heating medium flows through the heater 20 and does not flow through the bypass flow path 35. On the other hand, when the heater inlet valve 36 is closed and the bypass valve 37 is open, a second flow path is formed in which the heating medium flows through the bypass flow path 35 and does not flow through the heater 20.

Next, the hydrogen circuit 50 will be explained. The hydrogen circuit 50 is composed of a liquid hydrogen tank 51, a liquid hydrogen pump inlet pipe 52, a liquid hydrogen pump 53, a liquid hydrogen inlet pipe 54, a hydrogen tube 45, a hydrogen gas outlet pipe 56, a pressure reducing valve 57, and a hydrogen gas supply pipe 59.

The liquid hydrogen tank 51 is a tank that stores low-temperature liquid hydrogen inside. The liquid hydrogen pump inlet pipe 52 connects the liquid hydrogen tank 51 and the suction port of the liquid hydrogen pump 53. The liquid hydrogen inlet pipe 54 connects the discharge port of the liquid hydrogen pump 53 and the inlet of the hydrogen tube 45. Hydrogen gas outlet pipe 56 connects the outlet of hydrogen tube 45 and pressure reducing valve 57. A hydrogen gas temperature sensor 58 is attached to the hydrogen gas outlet pipe 56 to detect the vaporizer outlet hydrogen gas temperature TH. The hydrogen gas supply pipe 59 connects the pressure reducing valve 57 and the injector 16 of the hydrogen engine 15.

The cryogenic liquid hydrogen stored in the liquid hydrogen tank 51 is pressurized by the liquid hydrogen pump 53 and flows into the hydrogen tube 45 from the liquid hydrogen pump inlet pipe 52. The liquid hydrogen flowing through the hydrogen tube 45 exchanges heat with the high-temperature heating medium flowing through the outer surface of the hydrogen tube 45, and is vaporized to become hydrogen gas. The hydrogen gas flowing through the hydrogen tube 45 exchanges heat with the high temperature heating medium flowing through the outer surface of the hydrogen tube 45, becomes hydrogen gas at a predetermined temperature, and is released from the outlet of the hydrogen tube 45. It flows out into outlet pipe 56. After the hydrogen gas is reduced in pressure to the supply pressure to the hydrogen engine 15 by the pressure reducing valve 57, it is supplied to the injector 16 of the hydrogen engine 15 through the hydrogen gas supply pipe 59. The hydrogen gas is combusted inside the hydrogen engine 15 to generate driving force, and also increases the temperature of the coolant flowing through the internal flow path 17.

Hydrogen engine 15 is controlled by engine control unit 60. The engine control unit 60 is a computer that includes a CPU 61, which is a processor that processes information, and a memory 62 in which control programs and control data are stored. The engine control unit 60 adjusts the opening degree of the injector 16 to adjust the output of the hydrogen engine 15. The engine control unit 60 is connected to a start switch 18 attached to the hydrogen engine vehicle 200. The engine control unit 60 starts the hydrogen engine 15 when the start switch 18 is turned on, and stops the hydrogen engine 15 when the start switch 18 is turned off. Further, the engine control unit 60 communicates with a control unit 70, which will be described later, to exchange information. Engine control unit 60 outputs the output of hydrogen engine 15 and the on/off signal of start switch 18 to control unit 70.

The control unit 70 is a computer that includes a CPU 71, which is a processor that performs information processing, and a memory 72 that stores control programs and control data. The heater inlet valve 36, the bypass valve 37, the circulation pump 34, and the liquid hydrogen pump 53 are connected to the control unit 70 and are operated according to instructions from the control unit 70. The heating medium temperature sensor 38 and the hydrogen gas temperature sensor 58 are connected to the control unit 70, and the vaporizer inlet heating medium temperature TL detected by the heating medium temperature sensor 38 and the vaporizer outlet hydrogen gas temperature TH detected by the hydrogen gas temperature sensor 58 are input to the control unit 70. The control unit 70 also exchanges information with the engine control unit 60. The control unit 70 receives the output of the hydrogen engine 15 and the on/off signal of the start switch 18 from the engine control unit 60.

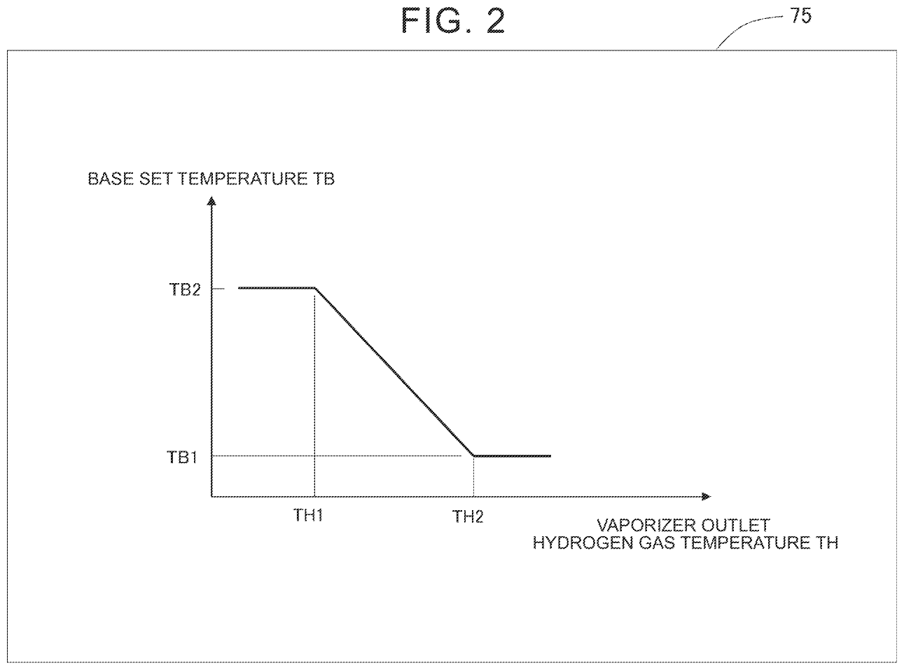

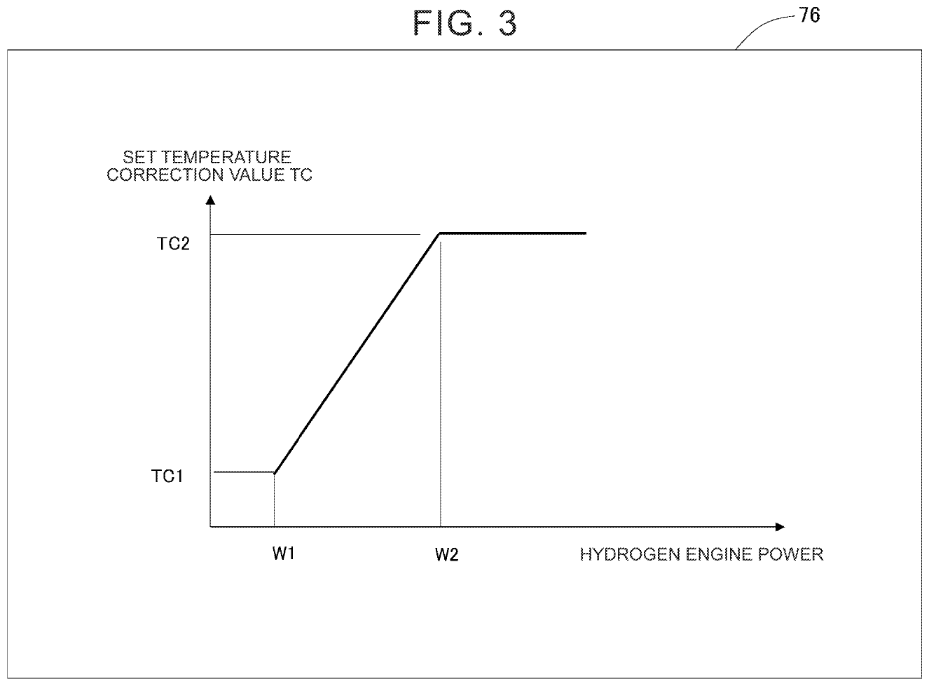

The control unit 70 stores in the memory 72 a base set temperature calculation map 75 shown in FIG. 2 and a set temperature correction value calculation map 76 shown in FIG. 3. The base set temperature calculation map 75 is a map that defines the base set temperature TB relative to the vaporizer outlet hydrogen gas temperature TH. The base set temperature TB is TB2 until the vaporizer outlet hydrogen gas temperature TH reaches TH1. When the vaporizer outlet hydrogen gas temperature TH is between TH1 and TH2 (TH2>TH1), the base set temperature TB decreases from TB2 to TB1 as the vaporizer outlet hydrogen gas temperature TH increases. Then, the base set temperature TB becomes constant at TB1 when the vaporizer outlet hydrogen gas temperature TH exceeds TH2. Further, the set temperature correction value calculation map 76 is a map that defines the set temperature correction value TC for the output of the hydrogen engine 15. The set temperature correction value TC is the minimum value TC1 when the output of the hydrogen engine 15 is smaller than W1. The set temperature correction value TC increases from TC1 to TC2 when the output of the hydrogen engine 15 increases from W1 to W2. Then, when the output of the hydrogen engine 15 exceeds W2, the set temperature correction value TC becomes constant TC2.

The control unit 70 calculates the set temperature TS using the following formula based on the base set temperature TB calculated using the base set temperature calculation map 75 and the set temperature correction value TC calculated using the set temperature correction value calculation map 76. Calculate by 1.

Set temperature TS=Base set temperature TB+Set temperature correction value TC (Formula 1)

The set temperature TS is a target value for temperature control of the vaporizer inlet heating medium temperature TL. When the vaporizer outlet hydrogen gas temperature TH becomes low, the control unit 70 increases the base set temperature TB to increase the temperature control target value of the vaporizer inlet heating medium temperature TL. Thereby, the control unit 70 performs advance control to increase the vaporizer inlet heating medium temperature TL to increase the vaporizer outlet hydrogen gas temperature TH when the vaporizer outlet hydrogen gas temperature TH becomes low.

Furthermore, when the vaporizer outlet hydrogen gas temperature TH increases, the control unit 70 lowers the base set temperature TB to lower the temperature control target value of the vaporizer inlet heating medium temperature TL. As a result, when the vaporizer outlet hydrogen gas temperature TH becomes high, advance control is performed to lower the vaporizer inlet heating medium temperature TL to lower the vaporizer outlet hydrogen gas temperature TH.

Further, as the output of the hydrogen engine 15 increases, the flow rate of hydrogen gas increases, and the vaporizer outlet hydrogen gas temperature TH decreases. On the other hand, when the output of the hydrogen engine 15 decreases, the vaporizer outlet hydrogen gas temperature TH increases. In this case, if the set temperature TS=base set temperature TB, the vaporizer outlet hydrogen gas temperature TH may significantly drop/rise due to an increase/decrease in the output of the hydrogen engine 15 due to a delay in control response. Therefore, in the hydrogen supply device 100 of the embodiment, advance control is performed to change the set temperature TS according to the output of the hydrogen engine 15 using the set temperature correction value calculation map 76 and Equation 1. This suppresses large fluctuations in the vaporizer outlet hydrogen gas temperature TH. That is, when the output of the hydrogen engine 15 increases, the set temperature correction value TC is increased so that the set temperature TS is increased by an amount that takes into account the decrease in the vaporizer outlet hydrogen gas temperature TH due to the increase in output. Furthermore, when the output of the hydrogen engine 15 decreases, the set temperature correction value TC is decreased so that the set temperature TS is lowered by an amount that takes into account the increase in the vaporizer outlet hydrogen gas temperature TH due to the decrease in output. Thereby, even if there is a fluctuation in the output of the hydrogen engine 15, the vaporizer outlet hydrogen gas temperature TH can be maintained within a predetermined temperature range using a simple method.

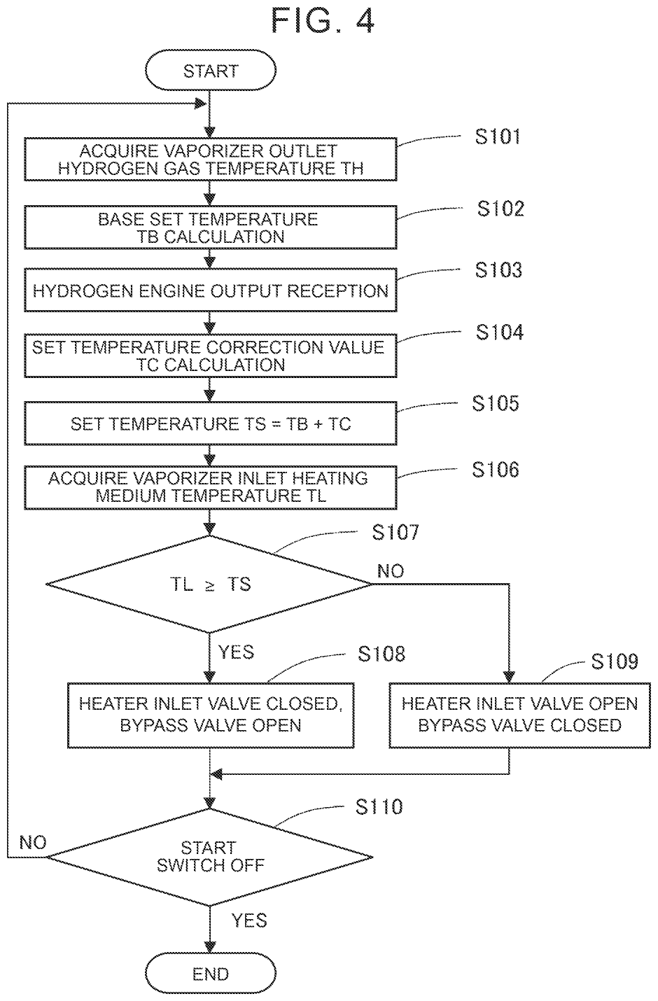

Next, the operation of the hydrogen supply device 100 will be explained with reference to FIG. 4. When the start switch 18 is turned on, the hydrogen engine 15 and hydrogen supply device 100 are started. The control unit 70 of the hydrogen supply device 100 acquires the vaporizer outlet hydrogen gas temperature TH using the hydrogen gas temperature sensor 58 in S101 of FIG. 4. The control unit 70 proceeds to S102 in FIG. 4 and calculates the base set temperature TB corresponding to the vaporizer outlet hydrogen gas temperature TH with reference to the base set temperature calculation map 75 stored in the memory 72.

In S103 of FIG. 4, the control unit 70 receives the output of the hydrogen engine 15 from the engine control unit 60. Then, in S104 of FIG. 4, the control unit 70 calculates a set temperature correction value TC corresponding to the output of the hydrogen engine 15 with reference to the set temperature correction value calculation map 76 shown in FIG. 3.

Next, the control unit 70 proceeds to S105 in FIG. 4 and calculates the set temperature TS using Equation 1 described above.

Next, the control unit 70 proceeds to S106 in FIG. 4 and obtains the vaporizer inlet heating medium temperature TL using the heating medium temperature sensor 38. The control unit 70 then proceeds to S107 in FIG. 4 and determines whether the vaporizer inlet heating medium temperature TL is equal to or higher than the set temperature TS. When the control unit 70 determines YES in S107 of FIG. 4, the process proceeds to S108 of FIG. 4, and closes the heater inlet valve 36 and opens the bypass valve 37. Thereby, a second flow path is formed in which the heating medium flows through the bypass flow path 35 and does not flow through the heater 20. In this case, the heating medium pressurized by the circulation pump 34 returns to the circulation pump 34 from the heating medium supply pipe 32 through the casing 41 of the vaporizer 40, the heating medium return pipe 33, and the bypass flow path 35.

On the other hand, if it is determined NO in S107 of FIG. 4, the control unit 70 proceeds to S109 of FIG. 4, opens the heater inlet valve 36, and closes the bypass valve 37. Thereby, a first flow path is formed in which the heating medium flows through the heater 20 and does not flow through the bypass flow path 35. In this case, the heating medium pressurized by the circulation pump 34 passes through the heating medium supply pipe 32, the casing 41 of the vaporizer 40, the heating medium return pipe 33, and the heating medium flow path 31 of the heater 20 to the circulation pump 34. Reflux.

After executing S108 or S109 in FIG. 4, the control unit 70 proceeds to S110 in FIG. 4. The control unit 70 determines whether an off signal for the start switch 18 has been received from the engine control unit 60 in S110. If the control unit 70 determines NO in S110 of FIG. 4, it returns to S101 of FIG. 4 and repeats the operations from S101 to S110. On the other hand, if the control unit 70 determines YES in S110 of FIG. 4, the process ends.

In this way, when the vaporizer inlet heating medium temperature TL is equal to or higher than the set temperature TS, the control unit 70 closes the heater inlet valve 36 and opens the bypass valve 37 so that the heating medium flows through the bypass flow path 35. A second flow path is formed in which the heater 20 does not flow. As a result, heat transfer from the hydrogen engine 15 to the heating medium is eliminated, the temperature of the heating medium decreases, and the vaporizer outlet hydrogen gas temperature TH decreases. On the other hand, when the vaporizer inlet heating medium temperature TL is less than the set temperature TS, the control unit 70 opens the heater inlet valve 36 and closes the bypass valve 37 to allow the heating medium to flow through the heater 20. A first flow path through which bypass flow path 35 does not flow is formed. As a result, the temperature of the heating medium increases due to heat transfer from the hydrogen engine 15 to the heating medium, and the vaporizer outlet hydrogen gas temperature TH increases. As a result, the hydrogen supply device 100 maintains the vaporizer outlet hydrogen gas temperature TH within a predetermined range, and it is possible to suppress a decrease in the output of the hydrogen engine 15 due to an increase in the temperature of the hydrogen gas or damage to hydrogen piping due to a decrease in the temperature of the hydrogen gas.

Further, the control unit 70 increases the set temperature correction value TC so as to increase the set temperature TS by an amount that takes into account the decrease in the vaporizer outlet hydrogen gas temperature TH due to the increase in the output of the hydrogen engine 15, and decreases the set temperature correction value TC so that the set temperature TS is lowered by an amount that takes into account the increase in the vaporizer outlet hydrogen gas temperature TH due to the decrease in the output of the hydrogen engine 15. Thereby, even if there is a fluctuation in the output of the hydrogen engine 15, the vaporizer outlet hydrogen gas temperature TH can be maintained within a predetermined temperature range using a simple method.

Note that in the hydrogen supply device 100, a liquid such as LLC is used as a heating medium that circulates in the circulation flow path 30. Therefore, the heating medium flowing back into the circulation flow path 30 has a large heat capacity. Thereby, the vaporizer outlet hydrogen gas temperature TH can be maintained within a predetermined temperature range by simple control of switching the heating medium flow path between the first flow path and the second flow path using the switching valve.

In the above description, the bypass valve 37 and the heater inlet valve 36 are defined as a switching valve configured to switch the flow path between the first flow path in which the heating medium passes through the heater 20 and not through the bypass flow path 35, and the second flow path in which the heating medium passes through the bypass flow path 35 and not through the heater 20. However, the present disclosure is not limited thereto. For example, the switching valve may be a three-way valve that switches the flow path between the bypass flow path side and the heater side.

Further, in the above description, the hydrogen supply device 100 was described as supplying hydrogen gas to the hydrogen engine 15 of the hydrogen engine vehicle 200, but the hydrogen supply device 100 is not limited to this. For example, hydrogen gas may be supplied to a fuel cell, which is a power plant mounted on a vehicle.

What is claimed is:

1. A hydrogen supply device comprising:
a heater that heats a heating medium;
a vaporizer that vaporizes liquid hydrogen into hydrogen gas using the heating medium that is heated;
a circulation flow path that circulates the heating medium between the heater and the vaporizer;
a bypass flow path connected to the circulation flow path so as to bypass the heater;
a switching valve that switches flow paths between a first flow path in which the heating medium flows through the heater and does not flow through the bypass flow path, and a second flow path in which the heating medium flows through the bypass flow path and does not flow through the heater; and
a control unit that adjusts operation of the switching valve, wherein
the control unit is configured to
switch a flow path of the heating medium to the first flow path by the switching valve when a temperature of the heating medium flowing into the vaporizer is lower than a set temperature, and
switch the flow path of the heating medium to the second flow path by the switching valve when the temperature of the heating medium flowing into the vaporizer is no lower than the set temperature.

2. The hydrogen supply device according to claim 1, wherein the control unit is configured to
receive input of output of a power plant to which the hydrogen gas flowing out from the vaporizer is supplied, and of temperature of the hydrogen gas flowing out from the vaporizer, and
calculate the set temperature based on the temperature of the hydrogen gas flowing out from the vaporizer, and the output of the power plant.

3. The hydrogen supply device according to claim 2, wherein the control unit is configured to
calculate a base set temperature based on the temperature of the hydrogen gas flowing out from the vaporizer,
calculate a set temperature correction value based on the output of the power plant, and
set a sum of the base set temperature and the set temperature correction value as the set temperature.

4. The hydrogen supply device according to claim 3, wherein the control unit is configured to
calculate the base set temperature such that the base set temperature becomes lower as the temperature of the hydrogen gas flowing out from the vaporizer rises, and
calculate the set temperature correction value such that the set temperature correction value increases as the output of the power plant increases.
